(19) United States
(12) Patent Application Publication
(10) Pub. No.: US 2009/0290350 A1
(43) Pub. Date: Nov. 26, 2009

(54) ELECTRONIC DEVICE AND LIGHT GUIDE EMPLOYED THEREIN

(75) Inventors: GUO-MIN ZHAO, Shenzhen City (CN); Chih-Yu Yeh, Tu-Cheng (TW); Shih-Chi Wong, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/332,333

(22) Filed: Dec. 10, 2008

(30) Foreign Application Priority Data
May 20, 2008 (CN) 200810301678.8

(51) Int. Cl. G02B 6/00; F21V 33/00

(52) U.S. Cl. 362/253; 362/551

(57) ABSTRACT

An electronic device includes a housing and at least one light guide. The housing defines at least one through hole configured with a specified pattern. The light guides are fixed in the housing, and each light guide includes a protrusion configured with the same pattern structure as that of the through hole. The protrusions are received in the through holes. The at least one light guide transmits light from at least one light source to the protrusion thereof, thereby displaying the specified pattern of the protrusion on an outer surface of the housing.

### BACKGROUND

1. Technical Field

The disclosure relates to an electronic device and a light guide used thereby.

2. Description of Related Art

Indicator lights, utilizing backlit patterns or decorations, are commonly used on electronic devices for indicating usage conditions or states thereof, such as on/off and network connection conditions. Generally, patterns are printed on a film, such as a polycarbonate (PC) film, which is adhered to the surface of a housing of the electronic device, and a light guide is set under/behind the pattern. A light source, such as an LED located corresponding to each light guide transmits light through the light guide to the surface of the housing, thereby backlighting the patterns printed on the film on the outer surface of the housing.

Typically, the patterns are printed on the film by ink-jet. In this way, when the film is backlit by the light source, light is transmitted through the film. However, a halo is formed around the patterns on the surface of the housing, degrading the clarity of the patterns.

Therefore, it is desirable to provide a light guide for electronic devices promoting clear indicator patterns.

### BRIEF DESCRIPTION OF THE DRAWINGS

FIG. 1 is a perspective view of an electronic device in accordance with the disclosure.

FIG. 2 is an exploded perspective view of the electronic device of FIG. 1.

FIG. 3 is a perspective view of light guides of the electronic device of FIG. 1.

FIG. 4 is a partial perspective view of the housing of the electronic device of FIG. 1.

FIG. 5 is a partial sectional view of the electronic device of FIG. 1.

### DETAILED DESCRIPTION OF EMBODIMENTS

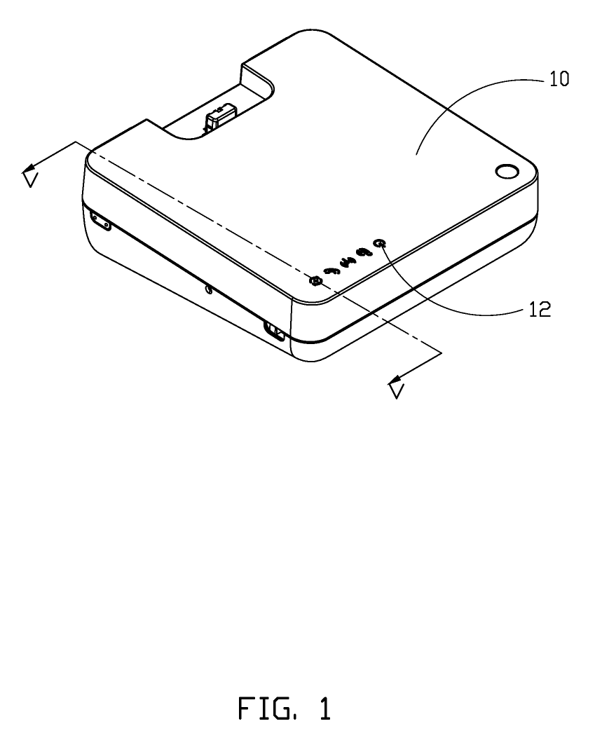

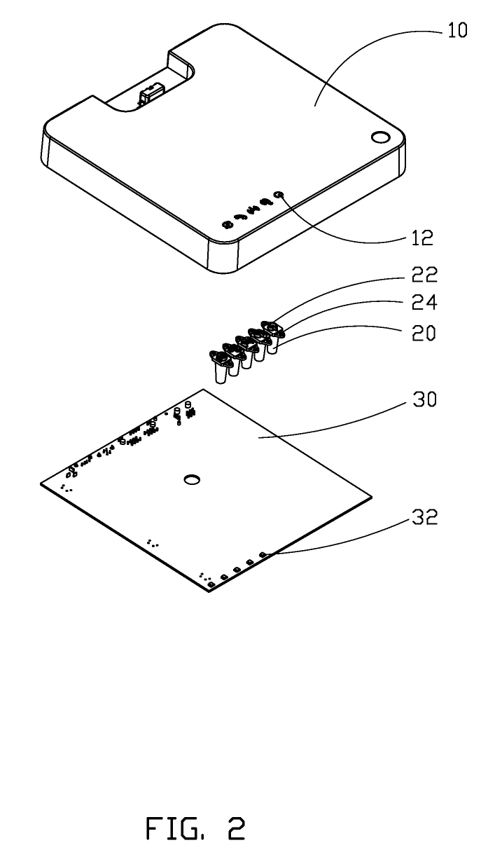

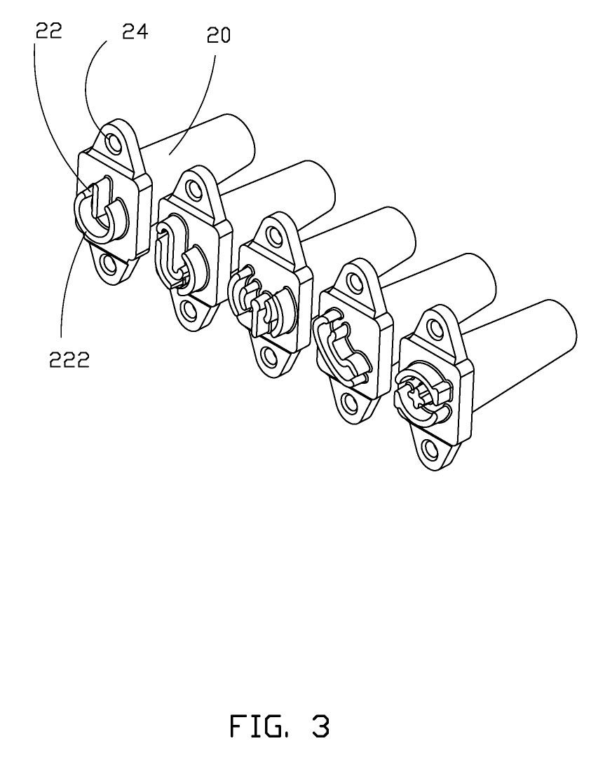

Referring to FIG. 1, FIG. 2, and FIG. 3, an electronic device comprises a housing 10 and at least one light guide 20. The housing 10 defines at least one through hole 12 configured with a specified patterned structure easily recognizable as indicating one or more usage conditions or states of the electronic device, such as on/off and network connection status. One end of the at least one light guide 20 includes a protrusion 22 configured with a patterned structure the same as that of the at least one through hole 12. The protrusion 22 is configured for a tight fit when received in the through hole 12.

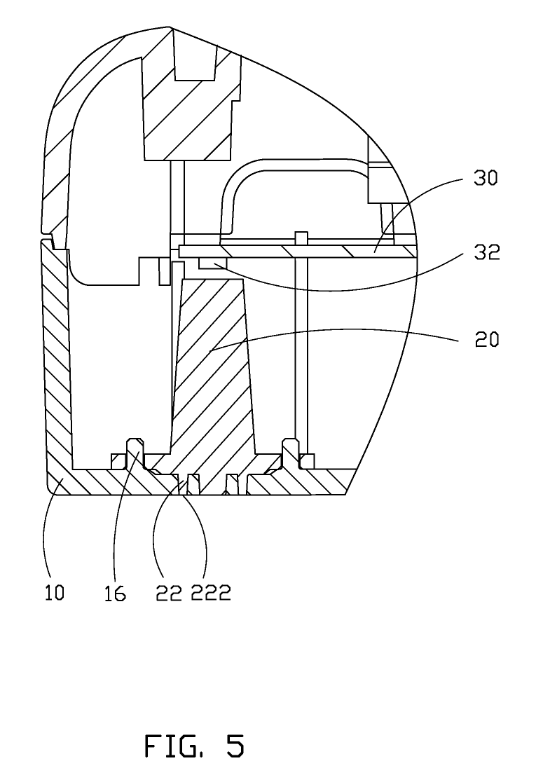

In this embodiment, the housing 10 is plastic, such as acrylonitrile-butadiene-styrene (ABS), polyvinyl chloride (PC), or high impact polystyrene (HIPS), as typically used in electronic devices. The height of the protrusion 22 is preferably equal to the depth of the through hole 12, such that when the guide 20 is installed in the housing 10 with the protrusion 22 mating with the through hole 12 in a tight fit, an end surface 222 of the protrusion 22 is substantially coplanar with the outer surface of the housing 10 (please refer to FIG. 5), such that a flat and smooth outer surface of the housing 10 is maintained. The protrusion 22 is integrally formed with the light guide 20 to improve light guiding performance. Each light guide 20 further defines at least one positioning hole 24 beside the protrusion 22.

At least one light source 32 fixed on the housing 10 corresponds to the at least one light guide 20. While here, the at least one light source 32 is located on a printed circuit board (PCB) 30, the at least one light source 32 can be fixed in any other suitable location, such as the inner surface of the housing 10 or a fixing element located in the housing 10 while remaining well within the scope of the disclosure. The at least one light guide 20 transmits light from the at least one light source 32 to irradiate the protrusion 22 of the light guide 20, thereby backlighting the specified pattern making it clearly visible on the outer surface of the housing 10.

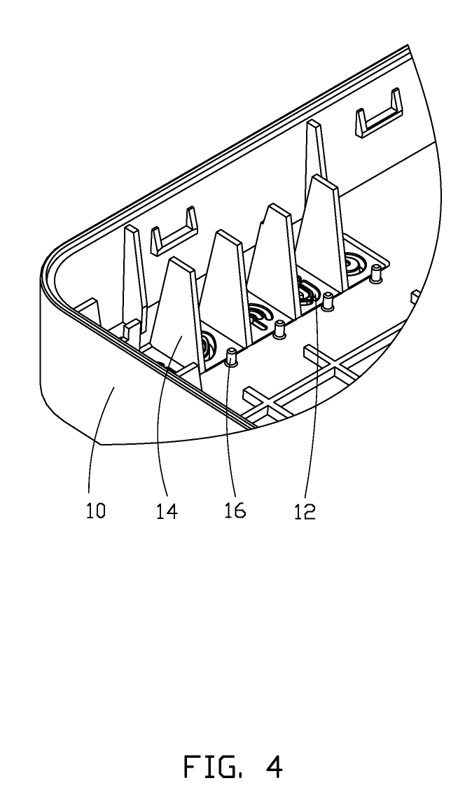

Referring to FIG. 4, at least one positioning post 16 extends from the inner surface of the housing 10. The positioning post 16 passes through the positioning hole 24, fixing the light guide 20 in the housing 10 of the electronic device. In this embodiment, the quantity of the through holes 12 and the light guides 20 is more than one, and at least one clapboard 14 is located between at least two of the neighboring through holes 12 isolating the light guides 20 corresponding to the at least two neighboring through holes 12, such that light from the light source 20 is fully and individually transmitted to the corresponding protrusion 22 and the clarity of the patterns is improved. In the embodiment, the housing 10 is any common opaque plastic material, and the positioning post 16 and the clapboard 14 are integrally formed with the housing 10.

Referring to FIG. 5, in which one light guide 20 is shown in cross section, when the light source 32 is turned on, the light guide 20 transmits light from the light source 32 to irradiate the corresponding protrusion 22. The brightly backlit pattern of the protrusion 22 is visible on the outer surface of the housing 10 with sufficient clarity, with no halo appearing around the protrusion 22. Furthermore, the structure of the outer surface is substantially flat due to the end surface 222 of the protrusion 22 being substantially coplanar with the outer surface of housing 10.

While exemplary embodiments have been described, it should be understood that they have been presented by way of example only and not by way of limitation. The breadth and scope of the disclosure should not be limited by the described exemplary embodiments, but only in accordance with the following claims and their equivalents.

What is claimed is:

1. An electronic device, comprising:
a housing defining at least one through hole configured with a specified pattern; and
at least one light guide fixed on the housing, each light guide comprising a protrusion configured with the same pattern as that of the through hole, the protrusion receivable in the through hole;
wherein the at least one light guide transmits light from at least one light source located in the housing to irradiate the corresponding protrusion.

2. The electronic device as claimed in claim 1, wherein the height of the protrusion is preferably equal to the depth of the through hole.

3. The electronic device as claimed in claim 2, wherein the protrusion snugly engages the through hole.

4. The electronic device as claimed in claim 1, wherein the quantity of the through holes and the light guides are more than one, and at least one clapboard is located between and isolating each two neighboring through holes.

5. The electronic device as claimed in claim 1, wherein the protrusion is integrally formed with the light guide.

6. The electronic device as claimed in claim 1, wherein the light guide is fixed to the housing.

7. The electronic device as claimed in claim 1, further comprising a printed circuit board fixed on the housing, on which the at least one light source is positioned.

8. The electronic device as claimed in claim 1, wherein the housing is opaque.

9. A light guide fixed in a housing of an electronic device, the light guide comprising a patterned protrusion suitably engaged with a through hole defined through the housing and corresponding to a light source configured within the housing for guiding light emitted by the light source to the patterned protrusion.

10. The light guide as claimed in claim 9, wherein the height of the protrusion is equal to the depth of the through hole.

11. The light guide as claimed in claim 10, wherein the protrusion snugly engages the through hole.

12. The light guide as claimed in claim 9, wherein the protrusion is integrally formed with the light guide.

13. The light guide as claimed in claim 9, wherein the light guide is fixed to the housing.

14. The light guide as claimed in claim 9, further comprising a printed circuit board fixed on the housing on which the light source is positioned.

15. The light guide as claimed in claim 9, wherein the housing is opaque.
